(19) United States
(12) Patent Application Publication
(10) Pub. No.: US 2024/0088744 A1
(43) Pub. Date: Mar. 14, 2024

(54) A LINEAR ACTUATOR COMPRISING A VISUAL STATUS INDICATOR

(71) Applicant: LINAK A/S, Nordborg (DK)

(72) Inventor: Jens Lorenzen, Broager (DK)

(21) Appl. No.: 18/273,944

(22) PCT Filed: Jan. 25, 2022
(86) PCT No.: PCT/DK2022/050013

§ 371 Date: Jul. 24, 2023

(30) Foreign Application Priority Data
Jan. 25, 2021 (DK) PA202100076

(51) Int. Cl. H02K 5/22; F16H 25/20; F16H 25/24; G08B 5/36; H02K 7/06

(52) U.S. Cl. CPC H02K 5/225; F16H 25/20; F16H 25/24; G08B 5/36; H02K 7/06; F16H 2025/2031; F16H 2025/2081

(57) ABSTRACT

Linear electric actuator (1) comprising a housing (10) with a reversible DC-motor (2), which through a transmission (3) can move an activation element (6) between two end positions, where an incremental position detection system is adapted to indicate the position of the spindle nut (5) during its travel on the spindle (4) and where the linear electric actuator further comprises a visual status indicator in the form of an LED arranged inside the housing configured to radiate light out of the housing through a light guide formed in the opening for insertion of an electrical plug into an electrical socket.

### TECHNICAL FIELD

The invention relates to a linear actuator comprising an electric motor, a transmission, a spindle, a spindle nut, a housing, an outer tube and an inner tube, the outer tube being connected to the housing, the spindle being connected to the transmission, the spindle nut being arranged on the spindle, the inner tube being connected to the spindle nut, the spindle nut and the inner tube being guided inside the outer tube.

### BACKGROUND

Linear actuators are widely used for various applications in a number of in-dustries and sectors including the care sector.

It is desired that a linear actuator is able to withstand the impact of a high-pressure water jet during the routine of cleaning.

It is also desired to avoid any fluid to enter the housing. Fluid entering the housing could potentially short circuit the electrical system or promote cor-rosion or clog the linear actuator mechanically in a way where it will be damaged.

It is further desired, for the reasons mentioned above, additionally to provide a linear actuator with a sealing which is able to prevent dirt and dust from entering the housing.

An object of the present invention is to provide a linear actuator for which a visible indication of the status of operation of the actuator is possible without jeopardizing the ability to endure the impact of a high-pressure water jet and prevent the water from entering the housing or prevent dirt and dust from entering the housing.

Generally, a visible indication of the status of the linear actuator is desirable in industrial and medical appliances. This especially is the case where a construction is configured such that a number of linear actuators are arranged in parallel. If one of the actuators fail, it can be difficult to determine which actuator failed without unplugging cables and performing measure-ments on the electrical network. In case an error occurs and the actuator has a visual status indicator, the technician will, in an easy way, be able to determine the specific component that is damaged and subsequently repair or replace the component in order to quickly make the machine operable again. However, in order to implement a visual indicator into the linear actuator, it will be necessary to make an opening or window in the linear actuator housing which will potentially jeopardize the sealing of the housing against penetration of dirt, dust and fluid into the component.

There seems to be a need for a solution to the outlined problem where the need for a visual indication of the status of the linear actuator does not jeopardize the sealing of the linear actuator against penetration of dirt, dust or fluid.

The above objects will be evident from the below detailed description.

According to an embodiment of the present invention, this is achieved by a linear actuator comprising a reversible DC-motor which through a transmission drives a spindle and thus applies a linear movement to a spindle nut retained against rotation, where the spindle nut is connected to an activation element, which can be displaced between two end positions on the spindle, further comprising a housing surrounding mechanical and electric components of the actuator, where the housing comprises an opening arranged to give access to an electrical socket by insertion of an electrical plug, and where the linear actuator comprises a light emitting indicator arranged inside the actuator housing and configured to radiate light in a direction out of said opening in the housing.

Since the linear actuator is provided with an opening intended for insertion of an electrical plug into an electrical socket, as well as utilizing said opening as a pathway for the transfer of light for showing a visual status of the linear actuator, there is no need for providing another opening or window for the status indicator. This has the obvious advantages of not introducing a possible entrypoint into the actuator housing for water or dust. If the linear actuator is configured with two openings for insertion of an electrical plug, and only one opening is needed for the purpose, the second opening can easily be adapted to form a visible status indicator. If all openings in the housing for insertion of a plug is used, further embodiments of the invention can be implemented.

Generally, in the embodiments of the invention, the actuator comprises a light guide formed of a translucent material arranged between the light emitting indicator and said opening of the housing.

In an embodiment, the light guide is formed as a ring adapted to fit into the opening in the housing. The extension of the ring is configured to have an extent in the longitudinal direction as to be in close proximity to the LED in the housing forming the source of light for the status indicator and protrude out to the outer surface of the housing in the opening, such as to be able to transfer the light out into a visible position outside the actuator housing.

The invention also relates to an electrical plug for insertion into an opening in a housing of a linear actuator, wherein said opening is arranged to give access to an electrical socket corresponding to the electrical plug, so that an electrical connection between the electrical plug and the electrical socket can be formed. The electrical plug comprises a light guide formed of a translucent material arranged to extend from a first end arranged at an outer end part of the electrical plug intended to connect with the electrical socket of the linear actuator to a second end arranged at an outer part of the electrical plug that is visible from the outside of the electrical plug.

In an embodiment, the light guide is formed in the plug by an electrical plug cover in a translucent material. The plug cover is configured to have an extent as to be (when the plug is inserted) in close proximity to the LED in the housing forming the source of light for the status indicator and protrude out to the outer surface of the housing through the opening, such as to be able to transfer the light out into a visible position outside the actuator housing.

In an embodiment, the electrical plug is connected to a cable comprising a cordage of wires, wherein the light guide is formed by at least one wire having a core of the wire or a cladding or jacket of the wire comprising a translucent material. Additionally, the core, cladding or jacket of the wire is configured to have an extent in the longitudinal direction in order to be in close proximity to the LED in the housing, forming the source of light for the status indicator, and an extent in the direction out of the opening to a point on the wire, which is configured with a bridge for transmitting the light out to the outer side of the electrical plug cover or the jacket of the cord in order to visibly emit the status indicator signal outside the actuator housing.

In an embodiment, the electrical plug is connected to a cable comprising a cordage of wires, wherein the light guide is formed in a cordage cover or a cable jacket comprising a translucent material.

In another embodiment, the light guide is formed by a cable strain relief comprising a translucent material.

The cordage cover, the cable jacket or the cable strain relief is inside the plug configured to be connected through to proximity and orientation for receiving and transmitting the light from the LED to outside the actuator housing. Since there will be optical resistance and reflection in the cordage cover or cable jacket, the light intensity will fade the longer the distance on the travel of the light in the material is.

For the embodiments, the translucent material is one of rubber, plastic, silicone, neoprene, etc.

The invention also relates to a dummy plug for insertion into an opening in a housing of a linear actuator, wherein said opening is arranged to give access to an electrical socket corresponding to an electrical plug, so that an electrical connection between the electrical plug and the electrical socket can be formed. The dummy plug comprises a light guide formed of a translucent material arranged to extend from an outer end part of the dummy plug intended to be inserted into the opening in the housing of the linear actuator to an outer part of the dummy plug that is visible from the outside when the dummy plug is inserted into said opening.

Since an opening not used for insertion of an electrical plug cannot be left without closing and sealing the opening against penetration of water or dust into the actuator housing, a dummy plug without any electrical function has to be inserted in order to provide the necessary sealing. Forming the light guide in the dummy plug can simply be implemented by letting the dummy plug comprise a translucent material and configure the plug as to form a light guide between the LED arranged in the housing and the outside of the housing. In an embodiment, the light guide is formed by the gasket arranged between the dummy plug and the port formed opening and formed of a translucent sealing material such as silicone, neoprene, rubber, etc.

An actuator system according to the invention comprises a linear actuator and an electrical plug as defined above. The first end of said light guide in the electrical plug is arranged to face said light emitting indicator in the linear actuator when the electrical plug is inserted into said opening of the linear actuator, and the second end of said light guide is arranged to be visible from the outside when the electrical plug is inserted into said opening.

A linear actuator according to the invention will be described more fully below with reference to the accompanying drawing, in which,

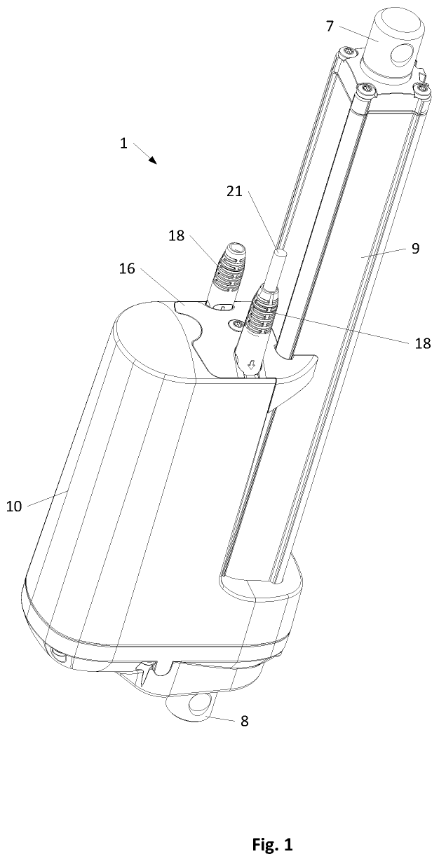

FIG. 1 shows a perspective view of a linear actuator,

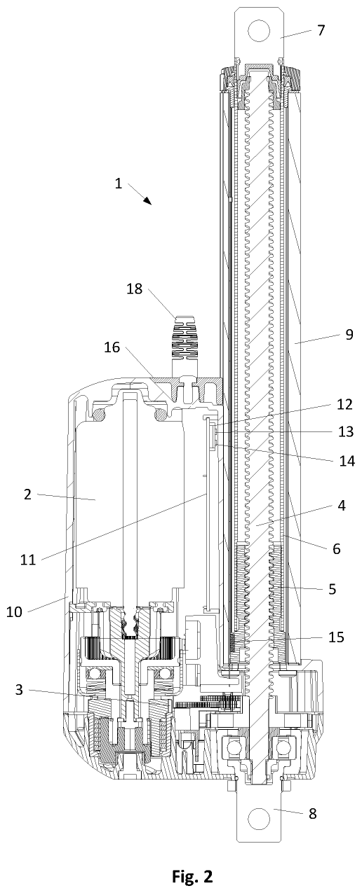

FIG. 2 shows a longitudinal section through a linear actuator,

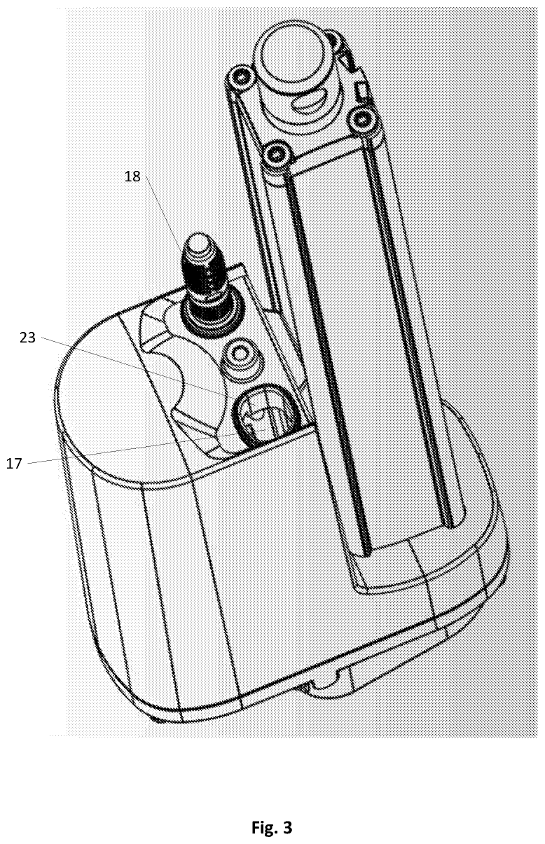

FIG. 3 shows a perspective view of a linear actuator with focus on the opening for insertion of an electrical plug,

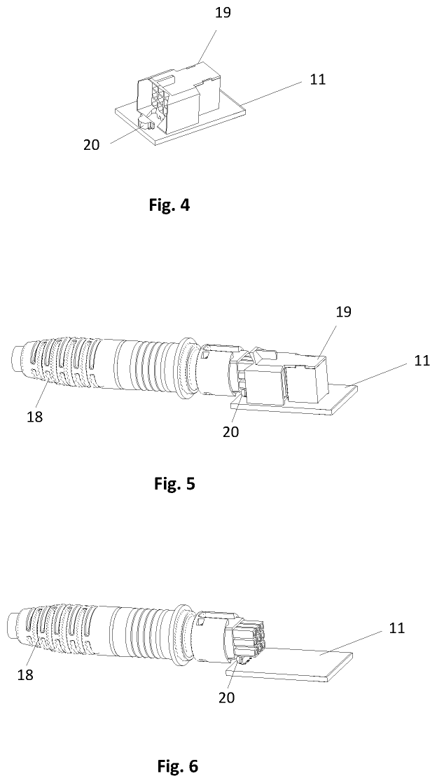

FIG. 4 shows a detailed view of a printed circuit board on which are arranged an electrical socket for an electrical plug and an LED,

FIG. 5 shows a detailed view of the printed circuit board where an electrical plug is inserted into the electrical socket,

FIG. 6 shows a detailed view of the printed circuit board where the electrical socket has been removed and where the electrical plug is arranged in its intended plugged position,

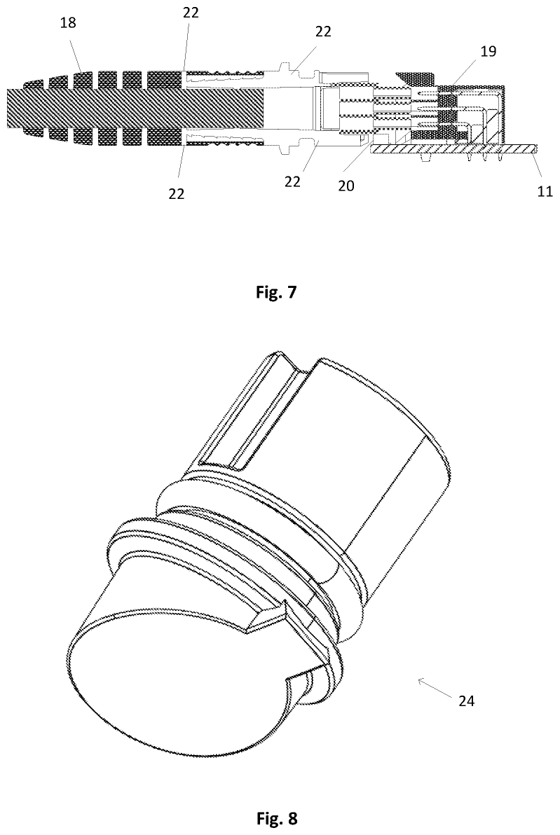

FIG. 7 shows a cross section through the linear actuator, with focus on the electrical plug in its connected state with the electric socket, and

FIG. 8 shows a dummy plug for insertion into an opening of a linear actuator.

FIGS. 1 and 2 show a schematic example of a linear electric actuator 1 shown in perspective and in a longitudinal section, respectively. The linear electric actuator 1 comprises a reversible electric motor 2, a transmission or a reduction gear 3, typically with multiple steps, a spindle 4, a spindle nut 5 in engagement with the spindle 4, and a tubular activation element 6, also known as an inner tube. At its one end, the activation element 6 is connected to the spindle nut 5 and, at the other end, the activation element 6 is equipped with a mounting bracket 7 for mounting the linear electric actuator 1. In addition to the mounting bracket 7, the linear electric actuator 1 also comprises a rear mounting 8 also intended for mounting. When the motor 2 through the transmission 3 rotates the spindle 4, the spindle nut 5 and the activation element 6 will move along the spindle 4. The activation element 6, the spindle nut 5 and the spindle 4 are arranged in an outer tube 9, which functions as a guide for the activation element 6. The spindle nut 5 is in engagement with one or more longitudinal grooves in the outer tube 9 and is thus secured against rotation. The linear electric actuator 1 further comprises a housing 10 in which the reversible electric motor 2, the transmission 3 and a printed circuit board 11 are arranged.

For determination of the position of the activation element 6 a position detection system (not shown) is integrated in the actuator, which counts the rotations of the spindle 4 or a different movable element in the actuator where the movement relates to rotations of the spindle 4. This could be rotations of the electric motor 2 or rotations of a gear wheel in the transmission 3. This is an incremental position detection system for which it applies that a reference is given to a known position of the spindle nut 5 during its travel on the spindle 4. Known positions can be an end position or a reference point located as a random desired location on the extent of the spindle 4. It is thus understood that the position detection system indicates the position by indication of a counter stage on a scale, which describes the dynamics area of the possible displacement movements of the activation element 6 by the linear actuator.

A control for the linear electric actuator is realized with electronic components built on a printed circuit board 11 located in the housing 10, separated from the mechanical parts of the actuator by means of a side wall. This has the obvious advantages that the electronics are not exposed to soiling by lubricant, which can damage the electronics.

A reference point is, as shown in FIG. 2, realized in that there in the control on the printed circuit board 11 is mounted a module in the form of a printed circuit board 12 equipped with at least one magnetic sensor. The printed circuit board 12 can be left out if the magnetic sensors are arranged directly on the printed circuit board 11 for the control. In the specific embodiment, the printed circuit board 12, however, has the advantage that the sensors 13, 14 can be arranged closer to the area in which the spindle nut 5 moves. The magnetic sensors 13, 14 are stroked by a magnet 15 arranged in connection with the spindle nut 5 when the spindle nut 5 moves past the point, where the magnetic sensors 13, 14 are arranged on travel of the spindle nut on the spindle 4.

The linear electrical actuator 1 is configured with an electrical interface through which the linear electrical actuator can be connected to a power supply for supplying a source of electrical energy and/or to exchange data or control signals. Further, the linear electrical actuator is configured with at least one electrical socket 19 that provides easy access to the electrical interface. FIGS. 1 and 2 shows an electrical plug 18 inserted into the electrical socket 19, and the electrical plug 18 has a wired connection in form of a cable 21 that can be run to a control for providing power and submitting and receiving control signals with the linear electrical actuator.

FIG. 3 shows a view of a linear electrical actuator with focus on the opening 17 in the linear electrical actuator for access to the electrical socket 19. The cable relief 16 that also function as retainer has been removed in order to get a focused view on the opening 17. As can be seen, the measure of the opening is configured to meet the form and size of the electrical plug 18 such that water and dust will be prevented from entering into the actuator housing 10 and potentially cause failure of the linear electrical actuator. In order to seal the opening 17, a gasket (not shown) can be inserted into the opening 17, or the electrical plug 18 can be adapted to include sealing means in form of a build in gasket. Inside the actuator housing 10 facing out into the opening 17, an electrical socket 19 is arranged in such a way that it is acceessable through the opening 17 by inserting an electrical plug 18.

In industrial machine appliancies in general, it is desired that the general state of a component can be easily monitored by visual inspection. This can help to quickly identify a component that has failed in order to exchange the component and put the machine back into production. Of course, this can only be applied if the individual component itself is adapted to perform a continuously running selfmonitoring and alerting of the status.

Often light indicators are used, radiating light in different colors depending on the state of the component. Of course, the presence of a single light indicator, whatever the color, could simply indicate that the component is powered. However, in more sophisticated products, a red visual light signal could indicate a failure, a yellow visual light signal a warning and a green signal that everything is ok, just like a traffic signal. Variations in flash fre-quency could also be used to differentiate visual state indications.

Normally, such indication lights will need an opening in the housing of the component. Either the indicator light can be arranged directly in the opening or behind a translucent window. Depending on the demand, it will be needed to include a sealing to avoid water or dust to enter the housing. Such openings and sealings add cost and fragility to the component and there is a need to find a better solution to the problem.

FIG. 4 shows a printed circuit board (PCB) 11 for fixing and electrically con-necting an electrical socket 19 in the linear electrical actuator 1. For the sake of simplicity, the PCB 11 is shown limited to the components of interest for explaining the invention. It could also have the extent shown in FIG. 2. A Light Emitting Diode (LED) 20 can be seen mounted in front of the electrical socket 19 in a position where the electrical plug 18 is intended to fit in. A view where the electrical plug 18 is in position in the electrical socket 19 can be seen in FIG. 5, and in FIG. 6 the electrical socket 19 is not shown in order to be able to see the position of the LED 20 being arranged in front of the electrical plug 18 (between the electrical socket 19 and the electrical plug 18) configured to radiate light in the direction towards the opening 17 in the actuator housing 10, where the electrical plug 18 is intended to be inserted.

When the electrical plug 18 is in position in the electrical socket 19, the opening 17 in the actuator housing 10 is filled out and as such it does not only function as a seal preventing water and dust in entering the actuator housing 10. It also blocks transmission of visual light since the actuator housing 10 is conventionally made of metal or throughcolored thick walled dark plastics since it needs to be robust in order to protect the component.

In the embodiment shown, the linear electrical actuator has two openings 17 for inserting an electrical plug 18. At least one of the openings 17 will be needed for supply of electrical current and for interchanging control signals. Often, the second opening 17 is used for serial coupling of further linear electrical actuators in a system. This can be linear electrical actuators that can be controlled individually or linear electrical actuators that are arranged to be controlled in parallel to each other in order to share a common load. If the second opening 17 is not used for insertion of an electrical plug 18, there will be a need to put a dummy plug (as an example, a dummy plug 24 is shown in FIG. 8) into the opening in order to avoid water and dust to enter the actuator housing 10. Such a dummy plug is provided with a sealing and is normally made of through colored plastics that blocks light from passing through the dummy plug. However, if the dummy plug is formed of translucent material in full or in part in such a way that it forms a light guide and is arranged from the opening intended for insertion of an electrical plug 18 to external to the linear electrical actuator housing 10, then the LED 20 arranged in the opening 17 intended for insertion of an electrical plug 18 of the linear electrical actuator will be allowed to radiate light out through the dummy plug and can be configured to serve as a visual status indicator. Thus, there will be no need for providing a specific opening in the housing reserved for a visual status indicator, thus avoiding a possible entrypoint for water or dust to enter the actuator housing 10. In this way, the dummy plug serves two purposes: 1) the sealing towards penetration of water or dust into the housing forming a gasket, and 2) as a light guide for visual indication by light of the status of the electrical actuator.

In an embodiment, the electrical plug 18 to be inserted into the opening 17, and forming an electrical connection with the electrical socket 19, comprises a light guide. The electrical plug 18 comprises metals and wires for the electrical connection but also fixating, retaining and isolation parts formed in plastics. The light guide is in an embodiment implemented by forming at least parts of the plastics parts of the electrical plug in a translucent material. Translucent plastics are preferred. The part formed in translucent material should extent from the outer part of the electrical plug 18 intended to connect with the electrical socket 19 to the outer part of the electrical plug 18 that is visible from outside of the actuator housing 10. In this way, the electrical plug 18 serves three purposes: 1) the electrical connection, 2) the sealing towards penetration of water or dust into the actuator housing 10 forming a gasket, and 3) as a light guide for visual indication by light of the status of the electrical actuator.

FIG. 7 shows a cross section through the electric linear actuator 1, with focus on the electrical plug 18 in its connected state with the electrical socket 19. The light guide 22 is an integrated part of the electric plug 18 and serves as a medium for transmitting the light from the LED 20 throughout the opening 17 in the housing 10 inside the electrical plug in the extent of the light guide 22. Where the light guide 22 is configured to be the outer surface of the electrical plug, light can escape and illuminate or color that particular part of the electrical plug. Thus, the status signal transmitted from the LED 20 will be visible outside the linear actuator by means of a transluminiscent part of the electrical plug 18.

In an embodiment shown in FIG. 3, a light guide in the form of a translucent ring 23 is inserted into the opening 17 in the actuator housing 10. The translucent ring 23 is configured to transmit the light emitted from the LED through the opening 17 in the actuator housing 10 and out of the actuator housing 10, where it will appear as a glowing ring surrounding the electrical plug 18 if inserted. Thus, the translucent ring 23 serves as a light guide for visual indication by light of the status of the electrical actuator. A translucent ring made of silicone could additionally serve as a sealing towards penetration of water or dust into the actuator housing 10 and as such have a dual purpose. The translucent ring could be adapted for being retained in the opening or be adapted for being arranged in fixed connection with the electrical plug 18.

For the sake of completion, the linear electric actuator comprises a microprocessor in the control, which handles functions in connection with the operation of the electric motor 2, including supervision of the motor speed and the overload circuit breaker. The position detection system can expediently be constructed with overall control from the microprocessor for the control, which is both an economic and practical solution, as the instructions for operation of the position detection system thus can be included in the general software package of the control for download in the control and for operation of the processes thereof. Additionally, the microprocessor can be configured to monitor the linear electric actuator and, in case the monitored data is outside boundaries set for normal and safe operation, put the state of the linear electrical actuator into an alert state. This state can be communicated through the electrical interface in form of data-communication, or visually by means of at least one LED 20 arranged with the linear actuator configured in such a way as to radiate light out of an opening 17, a window or from a light guide through the actuator housing 10.

The term “microprocessor”, which is used in the description, covers any unit which can fulfil the requirements for data processing of the described pro-cess carried out by the microprocessor mentioned in the description. When software is mentioned, it relates to portions of programme code, which in connection with the operation thereof in the microprocessor manages a monitoring and control function in the control of the actuator.

1. A linear actuator (1) comprising:
a reversible DC-motor (2), which through a transmission (3) drives a spindle (4) and thus applies a linear movement to a spindle nut (5) retained against rotation, where the spindle nut (5) is connected to an activation element (6), which can be displaced between two end positions on the spindle (4); and
a housing (10) surrounding mechanical and electric components of the actuator (1), where the housing comprises an opening (17) arranged to give access to an electrical socket (19) by insertion of an electrical plug (18),
characterized in that the linear actuator comprises a light emitting indicator (20) arranged inside the actuator housing and configured to radiate light in a direction out of said opening (17) in the housing.

2. A linear actuator (1) according to claim 1, characterized in that the linear actuator comprises a light guide formed of a translucent material arranged between the light emitting indicator (20) and said opening (17) of the housing.

3. A linear actuator (1) according to claim 2, characterized in that the light guide is formed as a ring (23) adapted to fit into the opening (17) in the housing.

4. A linear actuator (1) according to claim 2, characterized in that the translucent material is one of polymer or elastomer, such as rubber, plastic, silicone and neoprene.

5. An electrical plug (18) for insertion into an opening (17) in a housing (10) of a linear actuator (1), wherein said opening is arranged to give access to an electrical socket (19) corresponding to the electrical plug (18), so that an electrical connection between the electrical plug (18) and the electrical socket (19) can be formed,
characterized in that the electrical plug (18) comprises a light guide (22) formed of a translucent material arranged to extend from a first end arranged at an outer end part of the electrical plug (18) intended to connect with the electrical socket (19) of the linear actuator (1) to a second end arranged at an outer part of the electrical plug (18) that is visible from the outside of the electrical plug (18).

6. An electrical plug according to claim 5, characterized in that the light guide (22) is formed by an electrical plug cover in a translucent material.

7. An electrical plug according to claim 5, characterized in that the electrical plug is connected to a cable (21) comprising a cordage of wires, wherein the light guide is formed by at least one wire having a core of the wire or a cladding or jacket of the wire comprising a translucent material.

8. An electrical plug according to claim 5, characterized in that the electrical plug is connected to a cable (21) comprising a cordage of wires, wherein the light guide is formed in a cordage cover or a cable jacket comprising a translucent material.

9. An electrical plug according to claim 5, characterized in that the light guide is formed by a cable strain relief comprising a translucent material.

10. An electrical plug according to claim 5,
characterized in that the translucent material is one of polymer or elastomer, such as rubber, plastic, silicone and neoprene.

11. A dummy plug (24) for insertion into an opening (17) in a housing (10) of a linear actuator (1), wherein said opening is arranged to give access to an electrical socket (19) corresponding to an electrical plug, so that an electrical connection between the electrical plug and the electrical socket (19) can be formed,
characterized in that the dummy plug (24) comprises a light guide formed of a translucent material arranged to extend from an outer end part of the dummy plug (24) intended to be inserted into the opening (17) in the housing (10) of the linear actuator (1) to an outer part of the dummy plug (24) that is visible from the outside when the dummy plug (24) is inserted into said opening.

12. A dummy plug according to claim 11, characterized in that the translucent material is one of polymer or elastomer, such as rubber, plastic, silicone and neoprene.

13. An actuator system comprising a linear actuator (1) according to claim 1 and an electrical plug (18) according to claim 5,
characterized in in that the first end of said light guide (22) in the electrical plug (18) is arranged to face said light emitting indicator (20) in the linear actuator (1) when the electrical plug (18) is inserted into said opening (17) of the linear actuator (1), and that the second end of said light guide (22) is arranged to be visible from the outside when the electrical plug (18) is inserted into said opening (17).

14. An actuator system comprising:
a linear actuator comprising:
a reversible DC-motor connected to a transmission;
a spindle rotationally driven by the DC-motor through the transmission;
a spindle nut located on the spindle, the spindle nut being retained against rotation relative to the spindle; and
an activation element connected to the spindle nut, the activation element capable of being displaced between two end positions on the spindle;
a housing surrounding mechanical and electric components of the actuator, the housing comprising an opening configured to provide access to an electrical socket located inside the housing; and
a light emitting indicator arranged inside the housing configured to radiate light in a direction out of said opening in the housing; and
an electrical plug, the electrical plug being configured for insertion into the opening of the housing and connection to an electrical socket located inside the housing, the electrical plug comprising a light guide formed of a translucent material arranged between a first end located on the portion configured to connect with the electrical socket and a second end located on an outer portion of the electrical plug that is visible from the outside of the electrical plug.
